(19) United States
(12) Patent Application Publication
(10) Pub. No.: US 2012/0073143 A1
(43) Pub. Date: Mar. 29, 2012

(54) CUTTER KNIFE

(75) Inventor: Taichi Honda, Osaka-shi (JP)

(73) Assignee: KOKUYO CO., LTD., Osaka (JP)

(21) Appl. No.: 13/242,737

(22) Filed: Sep. 23, 2011

(30) Foreign Application Priority Data
Sep. 27, 2010 (JP) 2010-215357

(51) Int. Cl. B26B 1/08; B26B 5/00

(52) U.S. Cl. 30/162

(57) ABSTRACT

A cutter knife 10 includes a case 12 having a slit 27 in a top wall 22 constituting an upper end portion, a cutter blade 14 provided such that the cutter blade 14 may appear from a forward end of the case 12, and a slider 15 holding the cutter blade 14 and provided movably in a forward and rearward direction along a guide member 13 in the case 12. The slider 15 includes a slider body 42, an actuating member 44, and a plate spring 17, the plate spring 17 being provided to keep the actuating member in an initial position relative to the slider body.

### BACKGROUND OF THE INVENTION

1. Field of the Invention

The present invention relates to a cutter knife, and more particularly to a cutter knife including a mechanism that keeps an actuating member of a slider, which actuates a cutter blade such that it appears, in an initial position relative to a slider body.

2. Related Art

Publicly known cutter knives include a case having a substantially C-shape extending in a forward and rearward direction, a slider provided movably in the forward and rearward direction within the case, and a cutter blade which is held by the slider at a rear end side thereof. A locking mechanism is mounted between the slider and the case. By the locking mechanism, the cutter blade may protrude from a forward end of the case in a stepwise manner, and be held in place.

In the cutter knife of this type, the slider is positioned on the side surface side of the case. When used by a right-handed person, the cutter knife may be easily handled with the thumb of the right hand, but when used by a left-handed person, the cutter knife is very hard to use.

Then, for example, as described in Patent Document 1, the applicant has proposed, so-called, a universal cutter knife with an actuating member arranged on an upper end portion of a case so as to be independent from handedness. This cutter knife includes a slider having a slider body positioned within the case and an actuating member combined movably in a forward and rearward direction to the slider body, and a locking mechanism with a plate spring, which is placed between the slider body and the case, being provided engageably and disengageably on the case side thereof, such that the locking mechanism locks and unlocks the slider. By partially engaging the plate spring and the actuating member, the actuating member is configured to be kept in an initial position relative to the slider body.

### CITATION LIST

### Patent Document

[Patent Document 1]
Japanese Patent Application Laid-Open No. 2008-229076

### SUMMARY OF THE INVENTION

### Problem to be Solved by the Invention

The cutter knife described in Patent Document 1 includes bended portions on the rear end side of the plate spring, and on the other hand a protrusive portion on the actuating member side, such that the actuating member is configured to be kept in the initial position by positioning the protrusive portion between the bended portions. The cutter knife is configured such that when applying an actuating force to the actuating member, the bended portions are deformed in directions in which each bend angle thereof increases so that a certain amount of relative movement between the slider body and the actuating member is permitted, and thereby the slider moves forward and rearward.

However, the cutter knife described in patent Document 1 permits for the forward and rearward movement by changing the bend angle of the bended portion provided on the rear end side of the plate spring. Therefore, there exists so-called “play” in which the actuating member positioned in the initial position moves freely forward and rearward relative to the slider body. It is found that there are rooms for improving the responsiveness when an actuating force is applied and the smoothness of an initial position return operation of the actuating member when the actuating force is released, while increasing the reliability of a locking mechanism.

### Object of the Invention

The present invention has been proposed in view of the above disadvantage. It is an object of the present invention to provide a cutter knife in which an actuating member always may keep an initial position even when a slider body and the actuating member are combined movably relative to each other in a forward and rearward direction, and which transfers an actuating force to a slider, while keeping good responsiveness, when the actuating force is applied to the actuating member, and on the other hand is capable of realizing an rapid initial position return of the actuating member relative to the slider body when the actuating force is released.

### Means for Solving Problems

In order to achieve the above object, the present invention adopts an arrangement comprising a case having an inner space extending in a forward and rearward direction and a slit continuing to the inner space, the slit being formed in the forward and rearward direction on an upper end portion of the case, a cutter blade housed in the case and provided such that the cutter blade may appear from a forward end of the case, a slider holding the cutter blade and provided movably in the forward and rearward direction in the case, and a plate spring attached to the slider and provided disengageably on the case side to permit locking and unlocking the slider, the slider including a slider body located in the case, and an actuating member combined relatively movably in the forward and rearward direction relative to the slider body and located on the upper portion side of the case through the slit,

wherein an initial position keeping mechanism of the actuating member is provided between the slider body and the actuating member, the initial position keeping mechanism including a position-restricting portion provided in the plate spring, and a receiving portion provided in the actuating member and receiving the position-restricting portion; and

the actuating member is kept in an initial position relative to the slider body, while the position-restricting portion is received by the receiving portion, and on the other hand the relative movement between the slider body and the actuating member is permitted by displacing the position-restricting portion within the receiving portion.

In the present invention, such an arrangement may be adopted that the position-restricting portion includes a bended portion, whereas the receiving portion has a shape that undetachably receives the bended portion.

Further, it is possible to be arranged as follows: the position-restricting portion includes a substantially L-shaped bended portion, whereas the receiving portion has a hole that undetachably receives the bended portion.

Furthermore, such an arrangement is preferably adopted that the hole includes an inclined surface guiding a displacement of the bended portion.

Still further, the plate spring includes a single member arranged along one side surface of the slider body.

Also, such an arrangement is adopted that the plate spring includes a single member arranged along one side surface of the slider body, the actuating member includes a facing surface along another side surface of the slider body when the actuating member is combined with the slider body,

the plate spring includes a shift region located from one side surface to another side surface side of the slider body, and

the position-restricting portion being formed in the shift region.

### Advantages of the Invention

According to the present invention, the initial position keeping mechanism includes the position-restricting portion provided in the plate spring, and the receiving portion provided in the actuating member, and therefore the initial position of the actuating member is stably kept at a certain position in a state where the position-restricting portion is fit in the receiving portion. On the other hand, the position-restricting portion may exert an actuating force of the actuating member to the slider body simply by a displacement thereof within the receiving portion, while maintaining its own shape, when the actuating force directed to a forward and rearward direction is applied to the actuating member. Therefore, although the actuating member and the slider body may be relatively moved forward and rearward, a state where substantially no “play” is between the two is kept so that when the actuating force is applied to the actuating member, in response to this, the actuating force is exerted on the slider body, whereas the actuating member may immediately carry out a motion relative to the slider body to return to the initial position when the actuating force is released. Further, the position restricting portion may eliminate a disadvantage such as occurrence of a malfunction since the displacement occurs within the receiving portion.

Also, since the position-restricting portion includes the bended portion and the receiving portion has the shape that undetachably receives the bended portion, an initial position return mechanism may be extremely simply constituted.

Further, since the bended portion is substantially L-shaped, and the receiving portion has the hole or recess as a constitution, the bended portion may easily move within the hole in a forward and rearward direction, and the bended portion may smoothly move in a direction in which it appears in the hole.

In particular, in the case where the inclined surface is provided in the hole, the motion of the movement may be more smoothly carried out.

Also, since the plate spring includes the single member, the number of parts may be reduced and an assembling work is simplified, and the cost burden may be reduced.

### BRIEF DESCRIPTION OF THE DRAWINGS

FIG. 1 is a schematic perspective view of a cutter knife in accordance with an embodiment.

FIG. 2 is an exploded perspective view of the cutter knife.

FIG. 3 is a top view showing a state where a guide member is housed in a case.

FIG. 4(A) is a longitudinal sectional view of FIG. 3, and FIG. 4(B) is an enlarged cross sectional view taken along a line A-A of FIG. 4(A).

FIG. 5(A) is a top view of the guide member, and FIG. 5(B) is a central cross sectional view of the guide member.

FIG. 6 is a schematic perspective view showing a state where a cutter blade is held by a slider.

FIG. 7(A) is a front view of a slider body, and FIG. 7(B) is a back view of the slider body, FIG. 7(C) is a top view of the slider body, and FIG. 7(D) is a bottom view of the slider body.

FIG. 8(A) is a sectional view taken along a line B-B of FIG. 7(A), FIG. 8(B) is a sectional view taken along a line C-C of FIG. 7(A), FIG. 8(C) is a sectional view taken along a line D-D of FIG. 7(A), and FIG. 8(D) is a sectional view taken along a line E-E of FIG. 7(A).

FIG. 9(A) is a front view of a retaining member, FIG. 9(B) is a top view of the retaining member, FIG. 9(C) is a bottom view of the retaining member, FIG. 9(D) is a back view of the retaining member, and FIG. 9(E) is a sectional view taken along a line F-F of FIG. 9(D).

FIG. 10(A) is a front view of an actuating member, FIG. 10(B) is a back view of the actuating member, and FIG. 10(C) is a top view of the actuating member.

FIG. 11(A) is a left side view of the actuating member, FIG. 11(B) is a sectional view taken along a line G-G of FIG. 10(B), and FIG. 11(C) is an enlarged cross sectional view taken along a line H-H of FIG. 10(B).

FIG. 12(A) is a top view of a plate spring, FIG. 12(B) is a front view of the plate spring, FIG. 12(C) is a sectional view taken along a line I-I of FIG. 12(B), and FIG. 12(D) is a back view of the plate spring.

FIG. 13 is an operational explanatory view showing attachment of the cutter blade to the slider body.

FIG. 14 is an operational explanatory view showing a state where the cutter blade is pressed with the retaining member.

FIG. 15 is an operational explanatory view showing a state where a plate spring member is attached to the slider body.

FIGS. 16(A) to (D) are explanatory views illustrating an operation of an initial position keeping mechanism.

### DESCRIPTION OF THE PREFERRED EMBODIMENTS

Hereinafter, an embodiment of the invention will be described in detail with reference to the drawings. Note that as used herein, “forward” refer to a side where a fore-end of a cutter blade is located, and “rearward” refers to the opposite side.

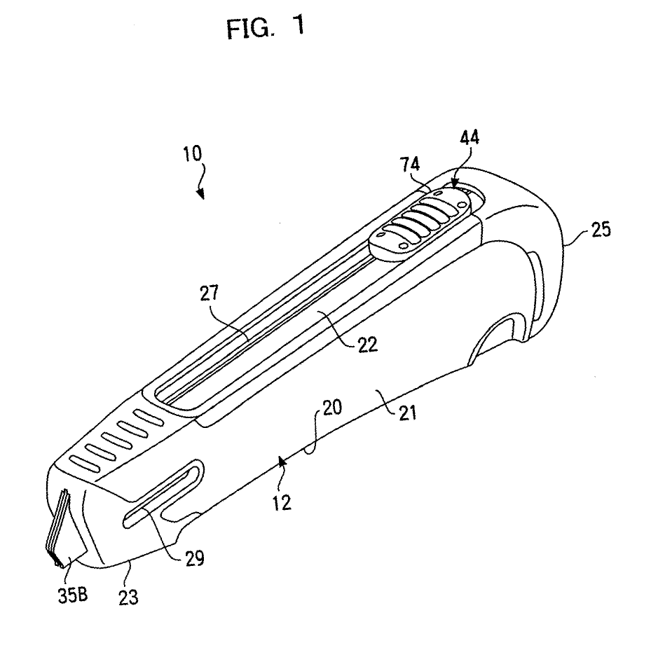

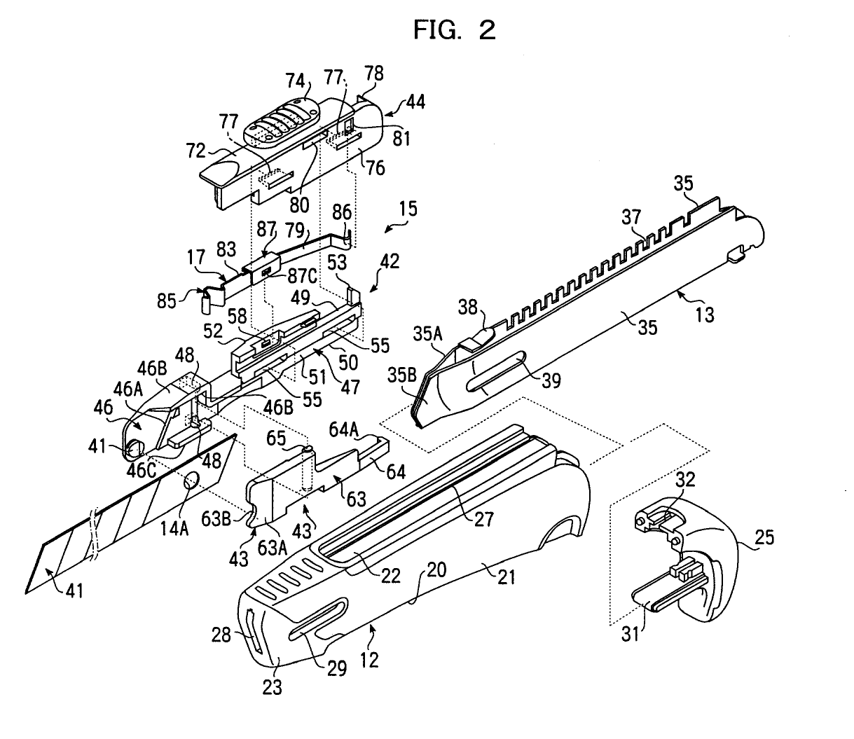

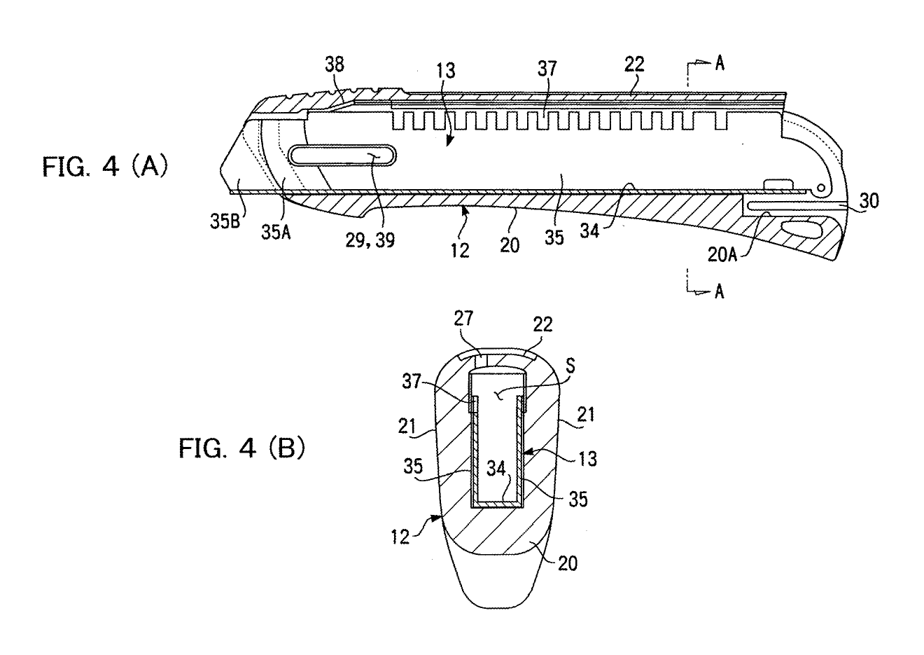

In FIGS. 1 and 2, a cutter knife 10 includes a case 12 having an inner space S extending in a forward and rearward direction (see FIG. 4(B)), a guide member 13 housed in the case 12, a cutter blade 14 provided movably in the forward and rearward direction along the guide member 13 such that it may appear from a forward end of the case 12, a slider 15 holding the cutter blade 14 and being provided movably along with the cutter blade 14 along the guide member 13, and a plate spring 17 provided between the slider 15 and the case 12, and being provided disengageably on the case 12 side to permit locking and unlocking the slider 15, thereby acting as a locking mechanism.

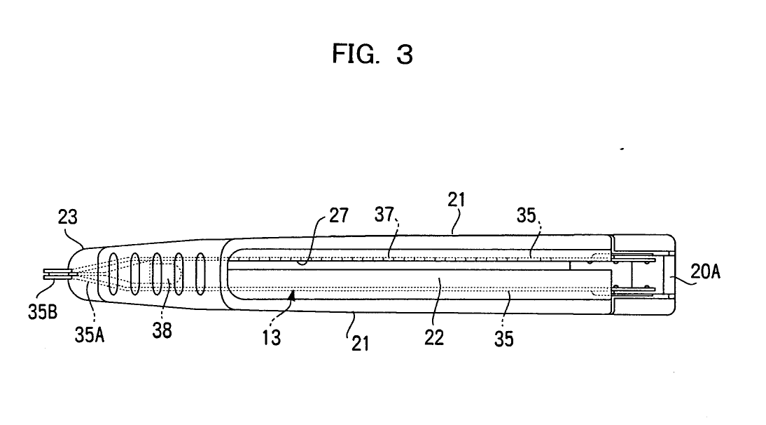

The case 12 has an elongated shape that extends in the forward and rearward direction and may be grasped by a palm of a hand. The case 12 includes a bottom wall 20 extending in the forward and rearward direction, a pair of side wall surfaces 21 continued from the bottom wall 20 in a smaller width direction of the bottom wall 20, and a top wall 22 continued between upper portions of the side wall surfaces 21. Each of the forward and rear ends of the case 12 is formed into an open shape, a cap 23 and a tail plug 25 being attached removably to the forward and rear ends, respectively. As shown in FIGS. 3 and 4(B), a slit 27 continuing to the inner space S is formed in the top wall 22 from the rear end to a location just before the forward end portion in a position somewhat shifted to one side wall surface 21 side. Also, a longitudinal opening 28 from which a fore-end region of the guide member 13 may protrude is formed in a forward end surface of the cap 23. A window opening 29 extending in the forward and rearward direction is formed in a region extending over the side wall surface 21 and the cap 23 to be capable of visually recognizing a remaining length of the cutter blade 14 located therein through the window opening 29. The case 12 of the embodiment is integrally molded of an appropriate resin material, and alternatively may be a two-piece type which has a mating face at the midpoint in a thickness direction (a direction perpendicular to a face of the side wall surface 21), or may be formed integrally with the cap 23.

As shown in FIG. 4, the bottom wall 20 has a one-step lower rear bottom wall 20A on the upper surface side of a rear end portion thereof. Each of opposite sides of the side wall surfaces 21 in a region of the lower rear bottom wall 20A has a groove portion 30 extending in the forward and rearward direction, and a protruding portion 31 formed in the tail plug 25 may fit in the groove portion 30. In the tail plug 25, a rear end thereof is a curved closed surface, and an upper end surface thereof includes a slit 32 which continues to the slit 27 formed in the top wall 22.

The cutter blade 14 is formed in a plate shape having a substantially parallelogram as viewed from the top with fore and rear ends inclined relative to an extending direction of a blade edge. The cutter blade 14 having the same structure as a publicly known cutter blade having a hole 14A at a rear portion thereof.

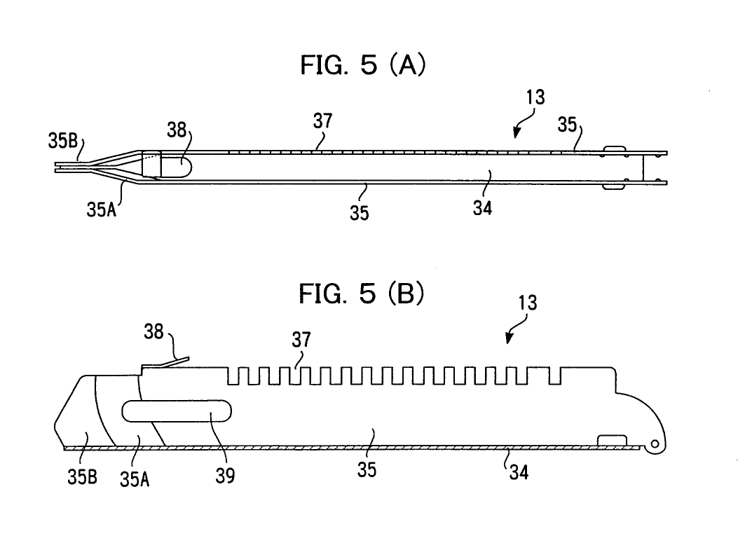

The guide member 13, as shown in FIG. 5, includes a base surface 34 located in substantially parallel relative to the bottom wall 20 and the side wall surfaces 21 of the case 12, and a pair of side wall surfaces 35 which are continued from both sides of the base surface 34 in a smaller width direction thereof, directed substantially vertically upward, and form a surface in substantially parallel to the cutter blade 14. On the forward end side of the side wall surface 35, there are inclined surface portions 35A, in which a width spaced apart from each other thereof gradually decrease, and parallel surface portions 35B which continues to forward ends of the inclined surface portions 35A and define a gap for substantially linearly guiding the passage of the cutter blade 14 in a vertical plane, such that the parallel surface portions 35B protrude forward through the longitudinal opening 28 formed in a forward wall 23 of the case 12.

A notch portions 37 in a constant pitch along the forward and rearward direction are formed in an upper end portion of one of the pair of side wall surfaces 35. In a more forward location, continuously provided is a tongue piece portion 38 which protrudes backwardly and upwardly. The tongue piece portion 38 is designed to define the limit of insertion when the guide member 13 is inserted from the rear end in the case 12. It is noted that in a forward region of the side wall surface 35, formed is an inner window opening 39 extending in the forward and rearward direction and overlapping with the window opening 29 of the case 12.

The slider 15 is configured to removably hold the cutter blade 14. The slider 15, as shown in FIG. 2, includes a slider body 42 having a protruding portion 41 fit within the hole 14A formed in the rear portion of the cutter blade 14, a retaining member 43 provided such that a rear end portion of the cutter blade 14 is to be put between the slider body 42 and the retaining member 43, and an actuating member 44 combined relatively movably in the forward and rearward direction relative to the slider body 42.

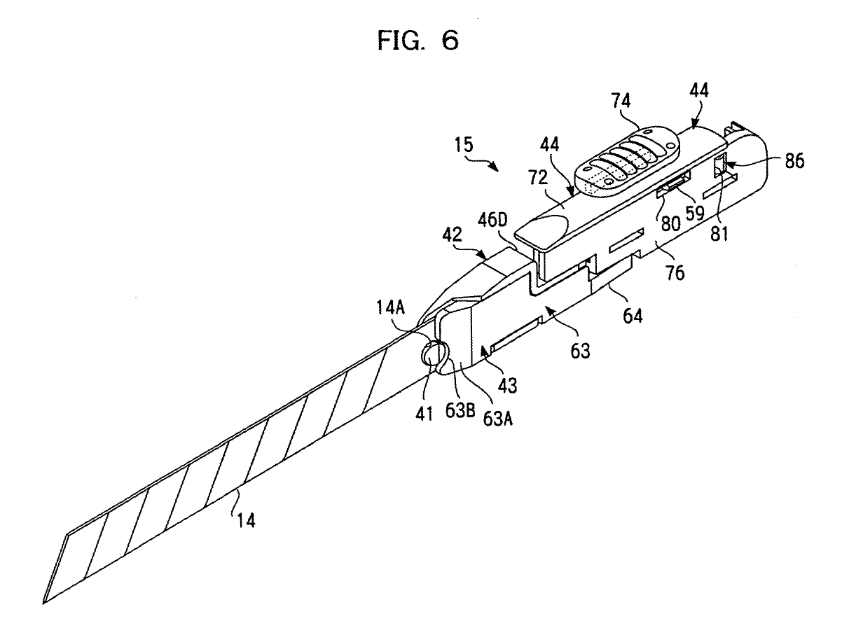

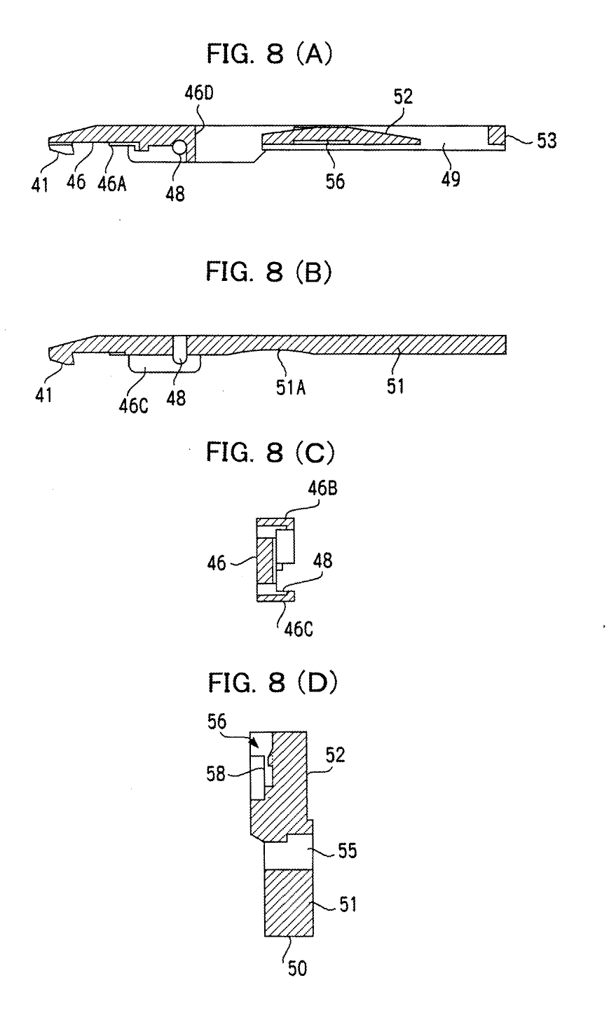

The slider body 42 has a plate-shaped contour, as viewed from the top, located in substantially parallel with a surface of the cutter blade 14 and extending in the forward and rearward direction. The slider body 42, as shown in FIGS. 6 to 8, includes a holding surface portion 46 located along one surface in the rear end portion of the cutter blade 14 and provided integrally with the protruding portion 41, and a mounting portion 47 continuing to a rear portion of the holding surface portion 46 and forming a mounting region of the actuating member 44. The holding surface portion 46 includes an inclined raised portion 46A formed on the inner surface side thereof, upper and lower horizontal portions 46B and 46C formed on the upper and lower sides, respectively, and a rear end 46D formed continuously to a rear end of the upper horizontal portion 46. The inclined raised portion 46A corresponds to the shape of a rear end edge of the cutter blade 14 to restrict the position of the rear end of the cutter blade 14. The upper horizontal portion 46B engages with an upper edge of the rear end of the cutter blade 14 to act as a rotation-restricting portion when the cutter blade 14 is temporarily held. Bearing portions 48 for swingably supporting the retaining member 43 are formed in the upper and lower horizontal portions 46B and 46C located rearward from the inclined raised portion 46A.

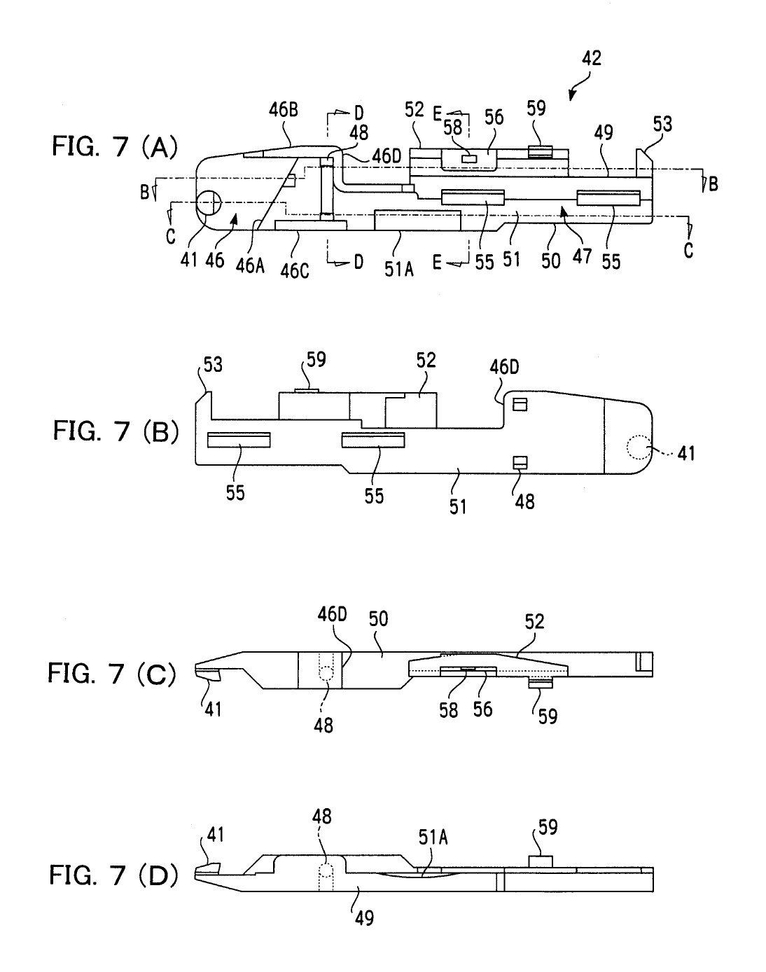

The mounting portion 47 includes upper and lower surface portions 49 and 50 continuing to the rear portion of the holding surface portion 46, and a front surface portion 51 between the upper and lower surface portions 49 and 50. The upper surface portion 49 is provided with, in the forward and rearward direction in a central section thereof, a spring-mounting portion 52 provided in an upwardly protruding manner, and a rising portion 53 at a rear end portion thereof. On the other hand, slot holes 55 directed in the forward and rearward direction are formed at two places in the forward and rearward direction in a surface of the front surface portion 51. The spring-mounting portion 52 has a recessed section 56 in a central section in an inner surface, on the near side in FIG. 7(A), a projection 58 formed in the recessed section 56, and a claw piece shaped protrusion portion 59 extending in the forward and rearward direction which is located rightward (rearward) from the recessed section 56. A curved recess 51A which partially decreases the thickness of the plate is formed in a lower portion of a side surface, on the near side in FIG. 7(A), of the front surface portion 51.

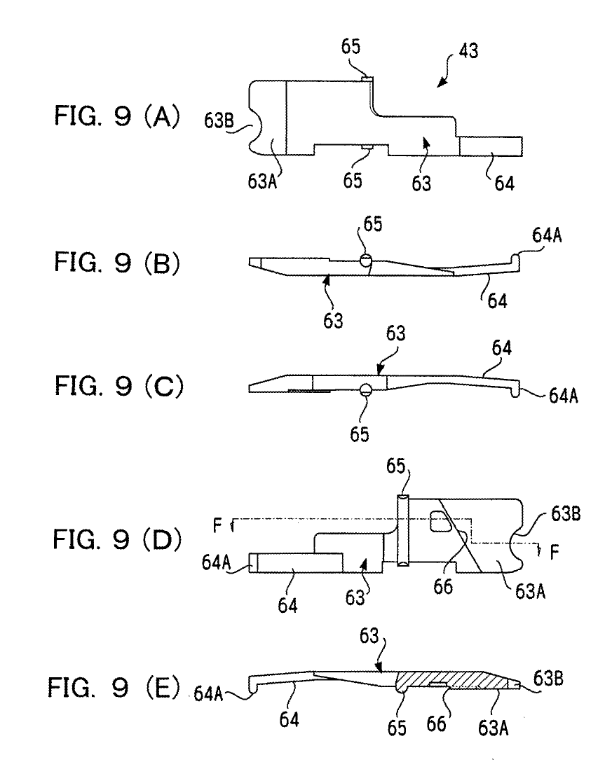

The retaining member 43, as shown in FIGS. 6 and 9, includes a body surface 63 located so as to extend over the holding surface portion 46 and the mounting portion 47, and an elongated pressing operation surface 64 continuing to the right side of the body surface 63 in FIG. 9(A). On the left end side of the body surface 63 in FIG. 9(A), formed is a retaining surface 63A having a notch 63B for receiving a substantially half of the protruding portion 41 of the slider body 42. As shown in FIG. 9(D), in a central section of the body surface 63, a pair of upper and lower protruding shafts 65 are provided, each fitting in the bearing portion 48 provided in the slider body 42, and on the right side of it, formed is a raised inclined portion 66 corresponding to an inclined edge of the rear end of the cutter blade 14. Moreover, the pressing operation surface 64 extends in a direction inclined relative to a surface of the body surface 63, and has a shape with a bended end 64A at a fore-end (rear end) thereof. The bended end 64A abuts against the mounting portion 47 of the slider body 42, and the pressing operation surface 64 leaves a clearance, used as a margin for pressing, between the pressing operation surface 64 and the curved recess 51A at a location where it faces the curved recess 51A provided in the mounting portion 47.

With reference to the retaining member 43, the body surface 63 may be swung about the axis of the protruding shaft 65 by pressing an outer surface side of the pressing operation surface 64 with a finger. Therefore, a forward end side of the body surface 63, i.e., a retaining surface 63A side in which the notch 63A is formed, is displaced in a direction close to and away from the holding surface portion 46 of the slider body 42 so that the cutter blade 14 may be attached and detached.

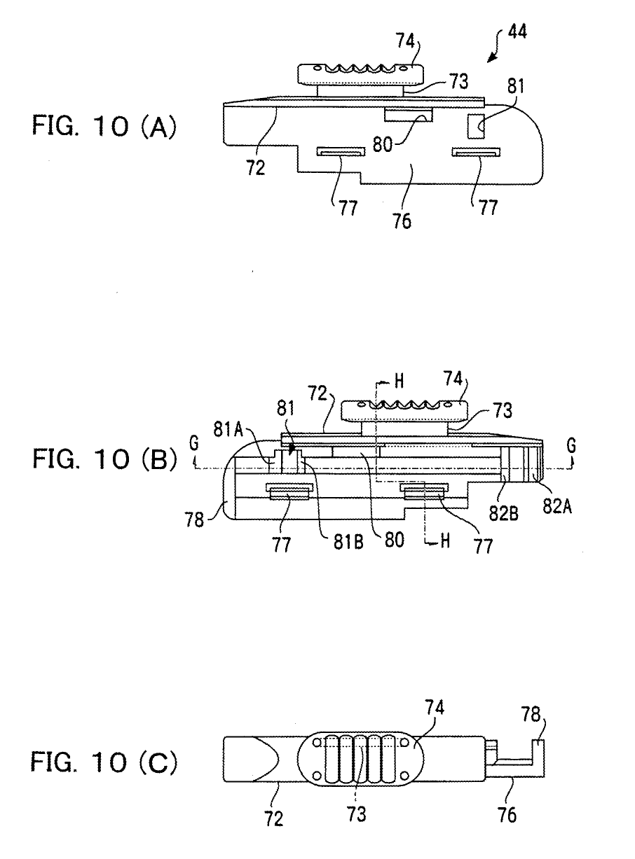

The actuating member 44, as shown in FIGS. 6, 10 and 11, includes an actuating planar surface 72 extending in the forward and rearward direction along the top wall 22 of the case 12, a connecting piece 73 continuously provided on an upper surface on the one end side, in a smaller width direction, of the actuating planar surface 72 and located in a state in which the connecting piece 73 passes through the slit 27 of the case 12, a finger touch part 74 continuously provided in a substantially cantilever position via the connecting piece 73, a drooped surface 76 continuously provided on the other side of the actuating planar surface 72 in a smaller width direction thereof and facing the mounting portion 47 of the slider body 42, as a facing surface, and insertion piece portions 77 provided at two places rearward and forward in a surface of the drooped surface 76 and undetachably inserted into the slot holes 55 of the slider body 42. The drooped surface 76, as shown in FIG. 10(C), has a length such that a rear end thereof is located rearward of a rear end of the actuating planar surface 72, and is provided with a rear end wall portion 78 at the rear end of the drooped surface 76. Moreover, the length in the forward and rearward direction of the insertion piece portion 77 is shorter than that of the slot hole 55 so that the actuating member 44 may be combined relatively movably along the forward and rearward direction relative to the slider body 42. The difference between the lengths of the actuating piece portion 77 and the slot hole 55 is substantially equal to the distance between a fore-end of the actuating member 44 and the rear end 46D continuing to the upper horizontal portion 46B of the slider body 42 when the actuating member 44 is kept in an initial position by combining the actuating member 44 with the slider body 42.

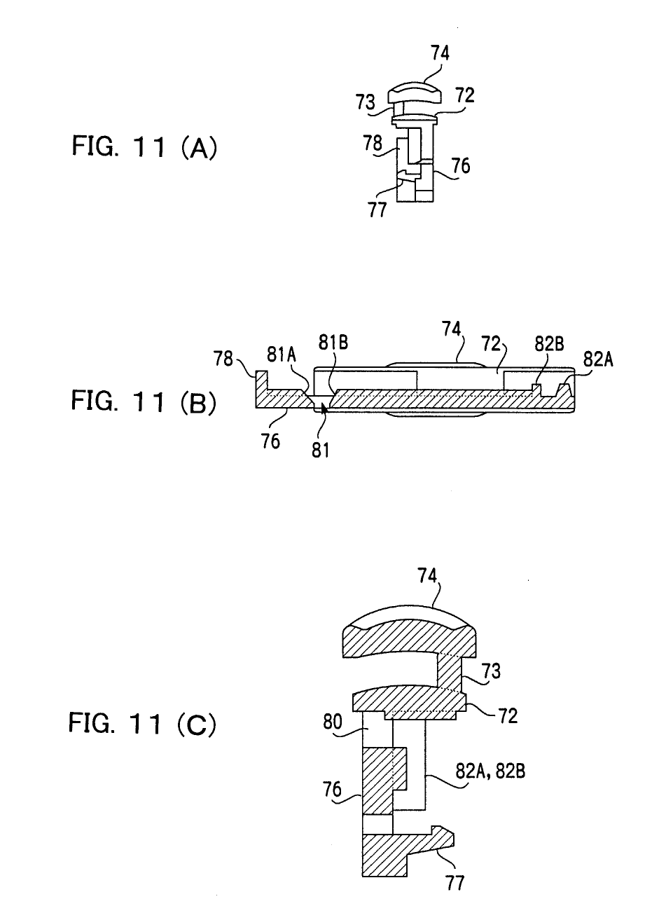

In the drooped surface 76, a slot portion 80 extending in the forward and rearward direction is formed over a location between the insertion piece portions 77, and the protruding portion 59 of the slider body 42 being capable of fitting movably in forward and rearward direction in the slot portion 80. Also, a hole 81 is formed as a receiving portion rearward of the slot portion 80, the hole 81 being capable of receiving a bended portion of the plate spring 17 as described below. The hole 81, as shown in FIG. 11(B), is formed into a pair of opposite inclined surfaces 81A and 81B with the width of the opening being large on the inner surface side (on the upper surface side in FIG. 11(B)) and small on the outer surface side (on the lower surface side in FIG. 11(B)). Moreover, forward and rearward projections 82A and 82B positioned at two places in the forward and rearward direction are formed on the inner surface side of a forward end of the drooped surface 76.

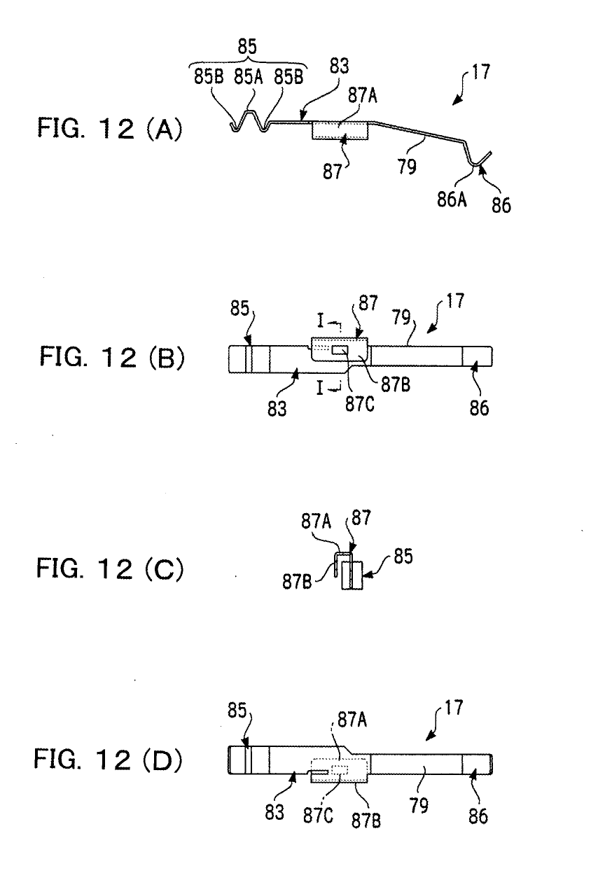

The plate spring 17, as shown in FIGS. 2 and 12, includes a spring body 83 extending in the forward and rearward direction, a forward bended portion 85 provided on the forward end side (on the left end side in FIG. 12(A)) of the spring body 83, a bended portion 86 as a position restricting portion provided on the rear end side, and a bent piece portion 87 provided in a central section of the spring body 83. The spring body 83 is designed to be located in a substantially vertical plane when the spring body 83 is attached to the slider body 42. In the spring body 83, a section located rearward from the bent piece portion 87 is referred to as a shift region 79 which is bent in a direction in which it is directed to the drooped surface 76 side of the actuating member 44 when assembling the slider 15.

The forward bended portion 85 includes a central bended portion 85A having a long bending length, and a pair of reinforcing bended portions 85B located on the both forward and rearward sides thereof. Moreover, the bended portion 86 which acts as the position restricting portion is formed by being bent into a substantially L-shape as viewed from the top, such that a bended edge 86A which a central section of the bended portion 86 is located on the hole 81 side, the hole 81 being formed in the drooped surface 76. Thus, the initial position keeping mechanism of the actuating member 44 is constituted by the bended portion 86 and the hole 81.

The bent piece portion 87, as shown in FIG. 12(C) includes a planar surface portion 87A, and a side surface portion 87B which is directed downward from a fore-end of the planar surface portion 87A. A square hole 87C is formed in a surface of the side surface portion 87B. The bent piece portion 87 wraps around the upper surface side of the spring-mounting portion 52 in the slider body 42 such that the projection 58 of the slider body 42 may fit into the square hole 87C.

Note that the cutter knife 10 of the embodiment has the substantially same components as, except for the slider 15, a cutter knife that has been disclosed in Japanese Patent Application Laid-Open No. 2008-229076 (Patent Document 1) which has been proposed.

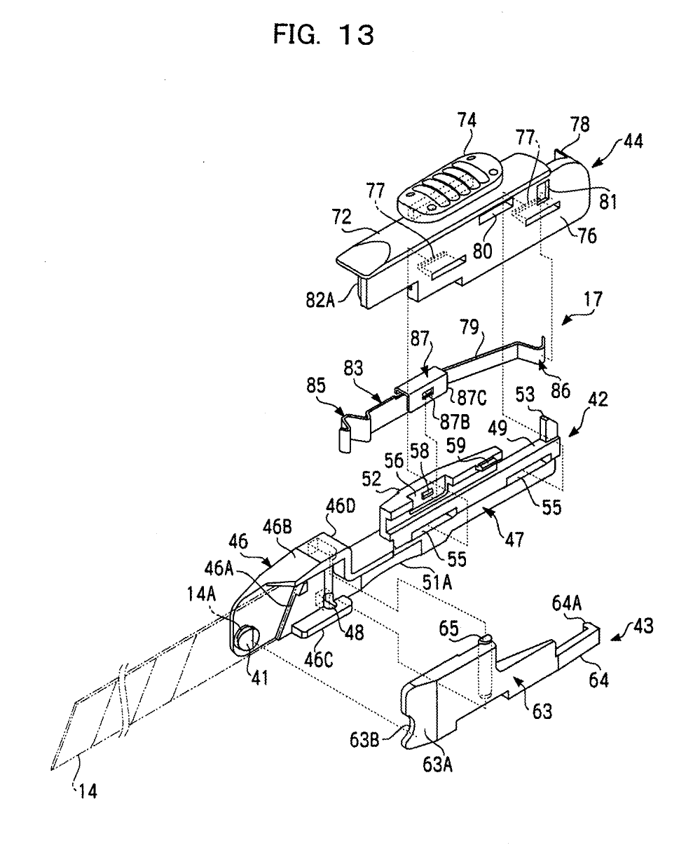

Then, a method for assembling and using the cutter knife 10 of this embodiment is described with reference to FIGS. 13 to 16.

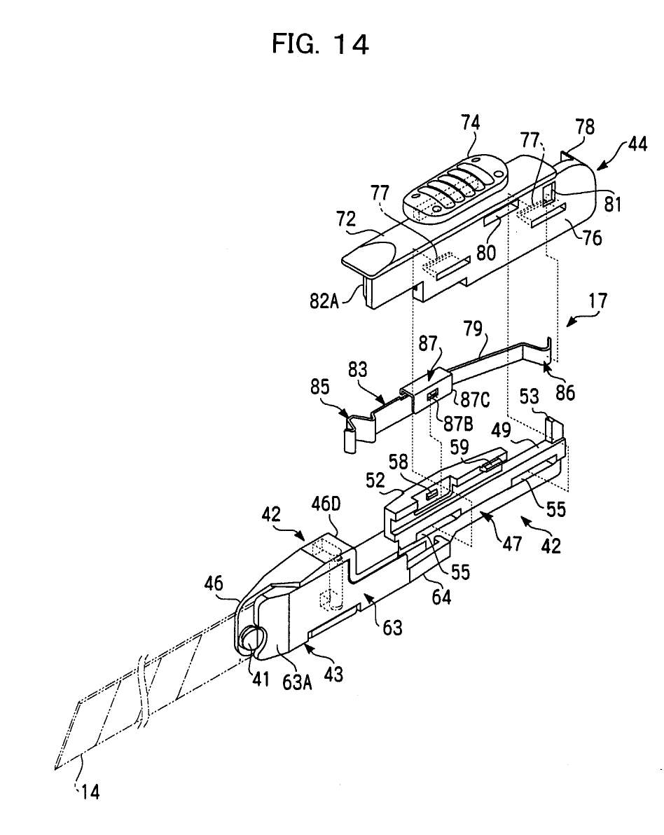

First, the guide member 13 is inserted from the rear portion of the case 12, and fit and fixed into the inner space S. Moreover, the slider 15 is obtained by combining the retaining member 43, the plate spring 17, and the actuating member 44 with the slider body 42 in that order. In this combining, firstly, the retaining member 43 and the slider body 42 are faced each other (see FIGS. 13 and 14), and in such a state are coupled together, while the protruding shafts 65 of the retaining member 43 are forcedly fit into the bearing portions 48 of on the slider body 42 side. Thus, the retaining member 43 may be swung in a direction in which the retaining surface 63A side gets close to or away from the holding surface portion 46 by pressing the pressing operation surface 64, so that a rear end portion of a cutter blade 14 may be caught therebetween. The attaching/detaching operation of the cutter blade 14 is the substantially same as that in Patent Document 1.

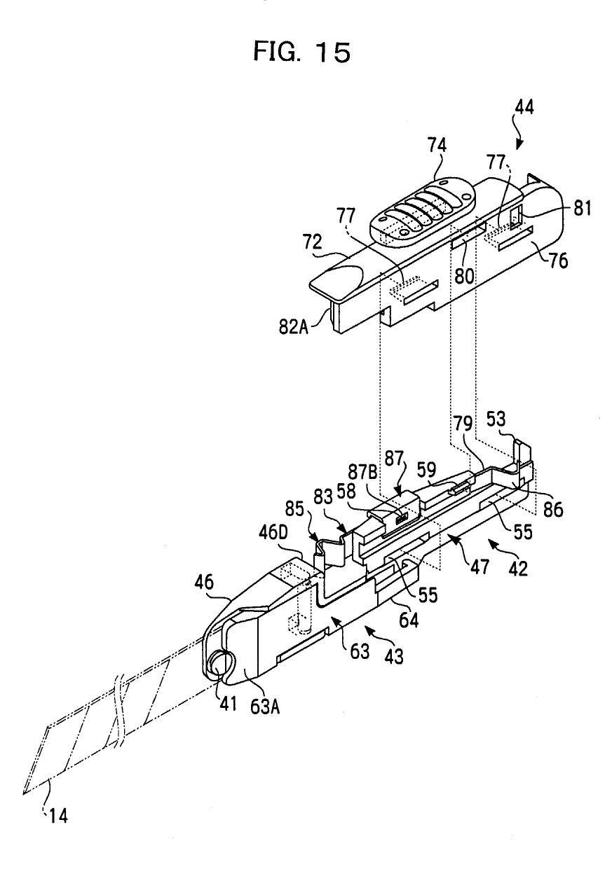

Then, the spring body 83 of the plate spring 17 is positioned along the outer surface side of the spring-mounting portion 52 in the slider body 42, the bent piece portion 87 is positioned so as to wrap around on the upper surface side of the spring-mounting portion 52, and the projection 58 of the slider body 42 is fit into the square hole 87C of the bent piece portion 87. Thus, the plate spring 17 is attached to the spring-mounting portion 52 in an indetachable manner. In a state where the plate spring 17 is attached to the spring-mounting portion 52, as shown in FIG. 15, the forward bended portion 85 is located between a forward end of the spring-mounting portion 52 and the rear end 46D of the holding surface portion 46, as well as the rear bended portion 86 is kept in a position shifted to the near side in the paper surface in FIG. 15, in from of the vicinity of the rising portion 53.

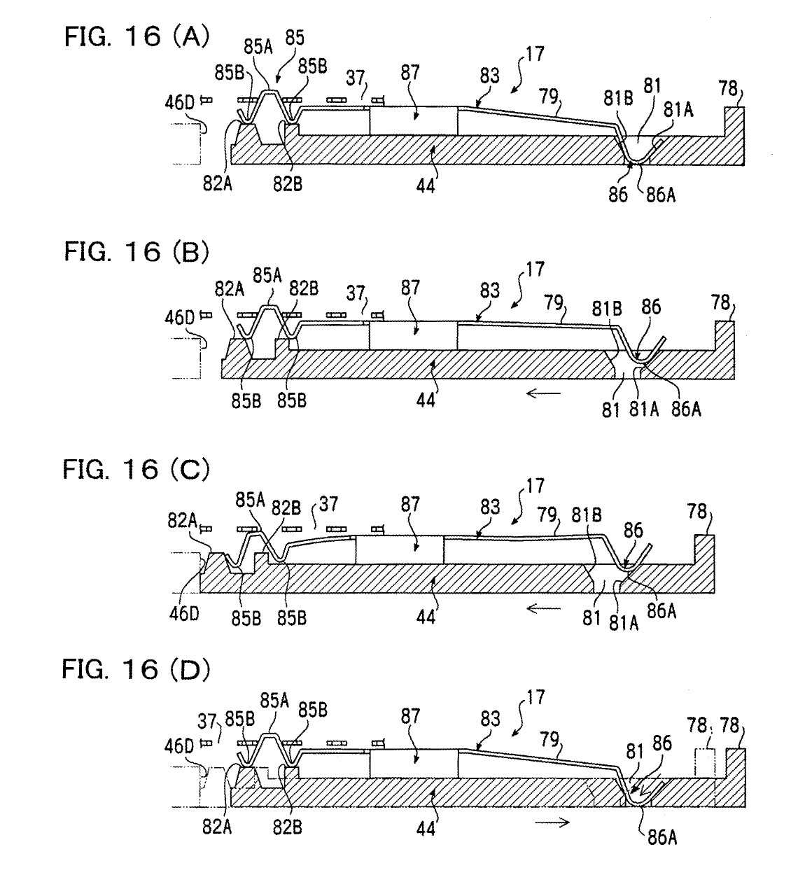

In a state where the plate spring 17 has been attached, the actuating member 44 is combined with the slider body 42. This combination may be performed by facing the drooped surface 76 of the actuating member 44 toward an inner side surface of the slider body 42, and inserting the insertion piece portions 77 into the slot holes 55. When this insertion is performed, at a time, the protrusion portion 59 of the slider body 42 is fit into the slot portion 80 of the actuating member 44, and the bended portion 86 of the plate spring 17 is kept in an initial position in which the bended portion 86 is fully received in the hole 81 of the actuating member 44. In this initial position, a pair of fore and rear reinforcing bended portions 85B provided in the plate spring 17 are placed on the forward and rear projections 82A and 82B of the actuating member 44 (see FIG. 16(A)), and moreover the central bended portion 85A is kept in a protruding position (locking position) at which the central bended portion 85A may engage with the notch portion 37 of the guide member 13. In this war, in a state where the slider 15 has been assembled, the cutter blade 14 may be caught and held between the retaining member 43 and the slider body 42 by pressing the pressing operation surface 64 of the retaining member 43.

A unit with the cutter blade 14 held by the slider 15 is inserted into the case 12, with the fore-end side of the cutter blade 14 being located as a leading end side in an insertion direction. In this case, the connecting piece 73 which supports the actuating member 44 in the cantilever position is located such that it passes through the slit 27 of a case body 12 in an up/down direction, so that the finger touch part 74 is located on the top wall 22. Then, the tail plug 25 is inserted and fit into a rear end portion of the case 12, and thus assembling of the cutter knife 10 may be completed.

For protruding the cutter blade 14 from the forward end of the case 12, it is only necessary to put a finger tip over the finger touch part 74, and apply an actuating force to the actuating member 44 in a forward direction (in a leftward direction in FIG. 16(A)), in the initial position as schematically shown in FIG. 16(A). As shown in FIG. 16(B), this causes the actuating member 44 to relatively move forward relative to the plate spring 17 attached to the slider body 42 so that the bended portion 86 starts to be displaced in a rising direction in the figure, while keeping in contact with the inclined surface 81A of the hole 81. Further, the actuating member 44 is moved forward, and thereby the forward end of the actuating member 44, hits the rear end 46D of the holding surface portion 46, and thus reaches the limit of movement. At this time, the bended portion 86 is displaced maximally within a range in which the bended portion 86 does not deviate from the hole 81, while keeping in contact with the inclined surface 81A, on the right side in FIG. 16, of the hole 81, and on the other hand the reinforcing bended portion 85B is permitted to slide off the forward and rearward projections 82A and 82B to enable the central bended portion 85A to get out of the notch portion 37 of the guide member 13. This leads to a state where the lock may be opened. Then, when the actuating member 44 moves forward in such a state, the slider 15 integrated with the cutter blade 14 may move forward within the case 12 to protrude the cutter blade 14 from the forward end. It is noted that when no actuating force is applied to the actuating member 44, the actuating member 44 moves in a direction to which the actuating member 44 moves back relative to the slider body 42 by exerting a force by which the bended portion 86 tends to return to an original position by utilizing a repulsive force that is applied by one inclined surface 81A, so that the bended portion 86 is fully received into the hole 81 thereby resulting in an initial position return state. Then, at this time, the reinforcing bended portions 85B are placed on the forward and rear projections 82A and 82B, and the central projection 85A is protruded, resulting in a locked state where the central projection 85A engages with the notch portion 37 again.

On the other hand, for retracting the cutter blade 14 into the case 12, it is only necessary to actuate the finger touch part 47 rearward. This causes the bended portion 86 of the plate spring 17 to be displaced, while kept in contact with the inclined surface 81B on the left side in FIG. 16 of the hole 81, whereas the reinforcing bended portions 85B to be displaced so as to permit they to slide off to the left side of the forward and rearward projections 82A and 82B, result in the substantially same operation as the operation when the actuating member 44 is moved forward. By releasing, at any location, the actuating force applied to the finger touch part 74, the actuating member 44 immediately returns to the initial position relative to the slider body 42.

Therefore, according to such embodiment, the initial position of the actuating member 44 relative to the slider body 42 may be stably kept in a position at which the central bended portion 85A engages with the notch portion 37 of the guide member 13, in a state where the bended portion 86 of the plate spring 17 is received in the hole 81 of the actuating member 44. Then, an operational feeling of the slider 15 with excellent responsiveness may be provided due to the bended portion 86 being displaced within the hole 81 while the central bended portion 85A and the notch portion 37 being disengaged when the actuating member 44 is actuated.

Moreover, an initial position return operation may be performed speedily and reliably since that the bended portion 86 is displaced and received such that it instantly falls down into the hole 81 when the actuating force of the actuating member 44 is released.

The best arrangement, method and the like for carrying out the present invention have been disclosed as described above. However, the present invention is not limited to the above.

That is, the present invention has been illustrated and described mainly about a specific embodiment. However, it is possible for those skilled in the art to add various modifications, if necessary, to the above-described embodiment with respect to shape, material, quantity, and other detailed arrangement without departing from the technical spirit and the range of the object of the present invention.

Accordingly, the description limiting the shapes, material, and the like disclosed above is described as an example in order to facilitate understanding of the invention, and is not intended to limit the invention. Therefore, the descriptions of parts name without part or all of the limiting of the shapes, material, and the like thereof are within the invention.

For example, although in the above embodiment, it illustrated that the bended portion 86 constituting the position-restricting portion is L-shaped, the shape is not limited as long as the substantially same action is obtained. Moreover, the same action and effect may also be obtained by forming a recess in the surface of the actuating member 44 instead of the hole 81 receiving the bended portion 86.

Further, the shape of the plate spring 17 may be variously modified. For example, the notch portion 37 provided in the guide member 13 may be in a pair arrangement similarly to the patent Document 1, while a pair of forward bended portions 85 which may engage and disengage with the pair of notch portions may be provided.

1. A cutter knife comprising a case having an inner space extending in a forward and rearward direction and a slit continuing to the inner space, the slit being formed in the forward and rearward direction on an upper end portion in the case, a cutter blade housed in the case and provided such that the cutter blade may appear from a forward end of the case, a slider holding the cutter blade and provided movably in the forward and rearward direction in the case, and a plate spring attached to the slider and provided engageably and disengageably on the case side to permit locking and unlocking the slider, the slider including a slider body located in the case, and an actuating member combined relatively movably in the forward and rearward direction relative to the slider body and located on the upper portion side of the case through the slit,
wherein an initial position keeping mechanism of the actuating member is provided between the slider body and the actuating member, the initial position keeping mechanism including a position-restricting portion provided in the plate spring, and a receiving portion provided in the actuating member and receiving the position-restricting portion; and
the actuating member is kept in an initial position relative to the slider body, while the position-restricting portion is received by the receiving portion, and on the other hand the relative movement between the slider body and the actuating member is permitted by displacing the position-restricting portion within the receiving portion.

2. The cutter knife according to claim 1, wherein the position-restricting portion includes a bended portion, whereas the receiving portion has a shape that undetachably receives the bended portion.

3. The cutter knife according to claim 1 or 2, wherein the position-restricting portion includes a substantially L-shaped bended portion, whereas the receiving portion has a hole or recess that undetachably receives the bended portion.

4. The cutter knife according to claim 3, wherein the hole or recess includes an inclined surface substantially corresponding to a shape of the bended portion.

5. The cutter knife according to claim 4, wherein the plate spring is constituted from a single member arranged along one side surface of the slider body.

6. The cutter knife according to claim 5, wherein the plate spring is constituted from a single member arranged along one side surface of the slider body, the actuating member includes a facing surface that faces another side surface of the slider body when the actuating member is combined with the slider body,
the plate spring includes a shift region bent from one side surface to another side surface side of the slider body, and
the position-restricting portion being formed at an end portion of the shift region.
